(19) United States
(12) Patent Application Publication
(10) Pub. No.: US 2017/0339242 A1
(43) Pub. Date: Nov. 23, 2017

(54) Content Placements for Coded Caching of Video Streams

(71) Applicant: Futurewei Technologies, Inc., Plano, TX (US)

(72) Inventors: Cedric Westphal, San Francisco, CA (US); Abinesh Ramakrishnan, San Jose, CA (US)

(21) Appl. No.: 15/160,548

(22) Filed: May 20, 2016

(51) Int. Cl. H04L 29/08; H04L 29/06

(52) U.S. Cl. CPC H04L 67/2842; H04L 67/06; H04L 65/1063; H04L 65/607; H04L 67/02

(57) ABSTRACT

A method implemented by a network element (NE) configured as a coordinated content coding using caches (c4) coordinator, the method comprising receiving, via a receiver of the NE, a first request from a first remote NE requesting a first file, receiving, via the receiver, a second request from a second remote NE requesting a second file, aggregating, via a processor of the NE, the first request and the second request according to first cache content information of the first remote NE and second cache content information of the second remote NE to produce an aggregated request, and sending, via a transmitter of the NE, the aggregated request to a content server to request a single common delivery of the first file and the second file with coded caching.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Internet traffic is increasingly dominated by content distribution services such as live-streaming and video-on-demand, where user requests may be predictable based on statistical history. In addition, content distribution services usually exhibit strong temporal variability, resulting in highly congested peak hours and underutilized off-peak hours. A common approach is to take advantage of memories distributed across the network, for example, at end users and/or within the network, to store popular contents that are frequently requested by users. This storage process is known as caching. For example, caching may be performed during off-peak hours so that user requests may be served from local caches during peak hours to reduce network load.

### SUMMARY

Coded caching is a content caching and delivery technique that serves different content requests from users with a single coded multicast transmission based on contents cached at user devices. However, current coded caching schemes that are used for downloadable files are relatively static and may not address the dynamic server-client interactions in streaming services. To resolve these and other problems, and as will be more fully explained below, a coordinated content coding using caches (c4) coordinator is used to dynamically identify coding opportunities among segment requests of clients during streaming.

In one embodiment, the disclosure includes a method implemented by a network element (NE) configured as a c4 coordinator, the method comprising receiving, via a receiver of the NE, a first request from a first remote NE requesting a first file, receiving, via the receiver, a second request from a second remote NE requesting a second file, aggregating, via a processor of the NE, the first request and the second request according to first cache content information of the first remote NE and second cache content information of the second remote NE to produce an aggregated request, and sending, via a transmitter of the NE, the aggregated request to a content server to request a single common delivery of the first file and the second file with coded caching. In some embodiments, the disclosure also includes determining, via the processor, that a coding opportunity is present when the first cache content information indicates that the second file is cached at the first remote NE and when the second cache content information indicates that the first file is cached at the second remote NE, wherein the first request and the second request are aggregated when determining that the coding opportunity is present, and/or starting, via the processor, a timer with a pre-determined timeout interval upon receiving the first request, and determining, via the processor, that the second request is received prior to an expiration of the timer indicating an end of the pre-determined timeout interval, wherein the first request and the second request are aggregated when determining that the second request is received prior to the expiration of the timer, and/or receiving, via the receiver, the first cache content information from the first remote NE, and receiving, via the receiver, the second cache content information from the second remote NE, and/or receiving, via the receiver, a coded file carrying a combination of the first file and the second file coded with the coded caching, and sending, via the transmitter, the coded file to the first remote NE and the second remote NE using a multicast transmission, and/or the coded file comprises a bitwise exclusive-or (XOR) of the first file and the second file, and wherein the coded file comprises a file header indicating a first filename of the first file, a first file size of the first file, a second filename of the second file, and a second file size of the second file, and/or receiving, via the receiver, at least an additional request from an additional remote NE requesting an additional file, determining, via the processor, an optimal coding opportunity among the first request, the second request, and the additional request according to the first cache content information of the first remote NE, the second cache content information of the second remote NE, and additional cache content information of the additional remote NE, and further aggregating the first request and the second request when determining that the optimal coding opportunity is between the first request and the second request, and/or the first file and the second file are associated with a scalable video coding (SVC) encoded video stream represented by a plurality of base layer files at a base quality level, a plurality of first enhancement layer files associated with a first quality level higher than the base quality level, and a plurality of second enhancement layer files associated with a second quality level higher than the first quality level, wherein the first cache content information indicates that the plurality of base layer files and the plurality of first enhancement layer files are cached at the first remote NE, and wherein the second cache content information indicates that the plurality of base layer files and the plurality of second enhancement layer files are cached at the second remote NE, and/or the first file and the second file are associated with a SVC encoded video stream represented by a plurality of base layer files at a base quality level, a plurality of first enhancement layer files associated with a first quality level higher than the base quality level, and a plurality of second enhancement layer files associated with a second quality level higher than the first quality level, wherein the first cache content information indicates that a first set of the plurality of base layer files and a second set of the plurality of first enhancement layer files associated with the first set are cached at the first remote NE, wherein the second cache content information indicates that a third set of the plurality of base layer files and a fourth set of the plurality of second enhancement layer files associated with the third set are cached at the second remote NE, and wherein the first set and the third set are different, and/or the first file and the second file are associated with a SVC encoded video stream represented by a plurality of base layer files at a base quality level and a plurality of first enhancement layer files associated with a first quality level higher than the base quality level, wherein the first cache content information indicates that a first portion of each of the plurality of base layer files and a second portion of each of the plurality of first enhancement layer files are cached at the first remote NE, wherein the second cache content information indicates that a third portion of each of the plurality of base layer files and a fourth portion of each of the plurality of first enhancement layer files are cached at the second remote NE, wherein the first portion and the third portion are different, and wherein the second portion and the fourth portion are different.

In another embodiment, the disclosure includes a NE configured to implement a c4 coordinator, the NE comprising a receiver configured to receive a first request from a first remote NE requesting a first file, and receive a second request from a second remote NE requesting a second file, a processor coupled to the receiver and configured to aggregate the first request and the second request according to first cache content information of first remote NE and second cache content information of the second remote NE to produce an aggregated request, and a transmitter coupled to the processor and configured to send the aggregated request to a content server to request a single common delivery of the first file and the second file with coded caching. In some embodiments, the disclosure also includes a memory configured to store a cache list, wherein the receiver is further configured to receive the first cache content information from the first remote NE, and receive the second cache content information from the second remote NE, and wherein the processor is further configured to update the cache list according to the first cache content information and the second cache content information, and/or the processor is further configured to aggregate the first request and the second request when determining that the first file is cached at the second remote NE and the second file is cached at the first remote NE according to the cache list, and/or the processor is further configured to start a timer with a pre-determined timeout interval when the first request is received, determine that the second request is received prior to an expiration of the timer indicating an end of the pre-determined timeout interval, and aggregate the first request and the second request when determining that the second request is received prior to the expiration of the timer, and/or the receiver is further configured to receive a coded file carrying a combination of the first file and the second file coded with the coded caching, and wherein the transmitter is further configured to send the coded file to the first remote NE and the second remote NE using a multicast transmission, and/or the content server is a dynamic adaptive streaming over hypertext transfer protocol (HTTP) (DASH) server, and wherein the first remote NE and the second remote NE are DASH clients.

In yet another embodiment, the disclosure includes a method implemented in a NE comprising sending, via a transmitter of the NE, a request to a c4 coordinator in a network requesting a first file, receiving, via a receiver of the NE, a coded file carrying a combination of the first file and a second file coded with coded caching from the c4 coordinator, obtaining, via processor of the NE, the second file from a cache memory of the NE, and obtaining, via the processor, the first file from the coded file by decoding the coded file according to the second file obtained from the cache memory. In some embodiments, the disclosure also includes decoding the coded file by performing a bitwise XOR operation on the coded file and the second file, and/or receiving, via the receiver, the request from a client application executing on the NE, and sending, via the transmitter to the client application, the first file extracted from the decoding, and/or sending, via the transmitter, a cache report to the c4 coordinator indicating contents cached at the cache memory.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating an embodiment of an adaptive video streaming representation scheme.

FIG. 2 is a schematic diagram illustrating an embodiment of a SVC representation scheme.

FIG. 3 is a schematic diagram of an embodiment of a coded caching-based content delivery system.

FIG. 4 is a schematic diagram of an embodiment of a NE.

FIG. 5 is a protocol diagram of an embodiment of a method of performing c4 in a coded caching-based content delivery system.

FIG. 6 is a protocol diagram of an embodiment of a method of performing c4 in a coded caching-based content delivery system under a timeout condition.

FIG. 7 is a flowchart of an embodiment of a method of performing c4 proxy in a coded caching-based system.

FIG. 8 is a flowchart of another embodiment of a method of performing c4 proxy in a coded caching-based system.

FIG. 9 is a flowchart of an embodiment of a method 900 of performing client proxy in a coded caching-based system.

FIG. 10 is a schematic diagram of an embodiment of a SVC content placement scheme.

FIG. 11 is a schematic diagram of another embodiment of a SVC content placement scheme.

FIG. 12 is a schematic diagram of another embodiment of a SVC content placement scheme.

FIG. 13 is a schematic diagram of another embodiment of a SVC content placement scheme.

FIG. 14 is a graph comparing average bandwidth usages of the SVC content placement schemes of FIGS. 10-13.

FIG. 15 is a graph illustrating playback bit rates under a timeout period of zero second.

FIG. 16 is a graph illustrating a cumulative distributed function (CDF) of playback bit rates under a timeout period of zero second.

FIG. 17 is a graph illustrating playback bit rates under a timeout period of one second.

FIG. 18 is a graph illustrating a CDF of playback bit rates under a timeout period of one second.

FIG. 19 is a graph illustrating playback bit rates under a timeout period of two seconds.

FIG. 20 is a graph illustrating a CDF of playback bit rates under a timeout period of two seconds.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

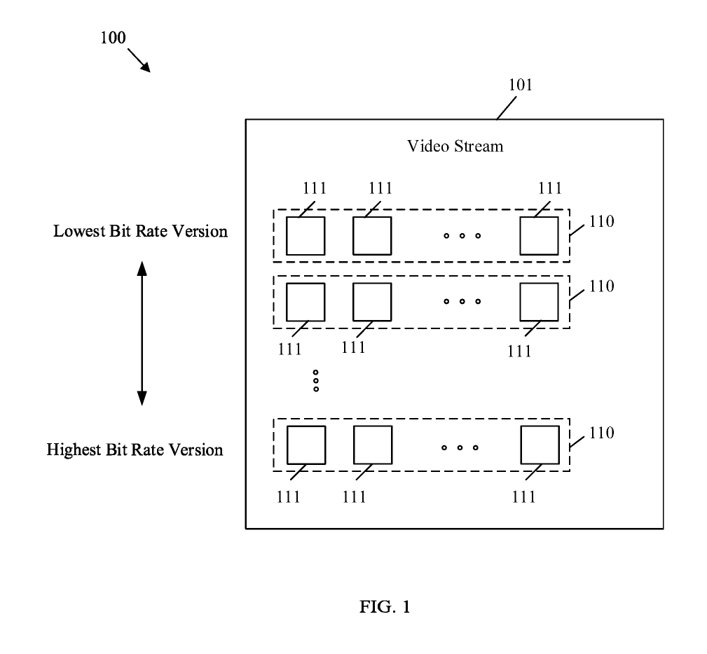

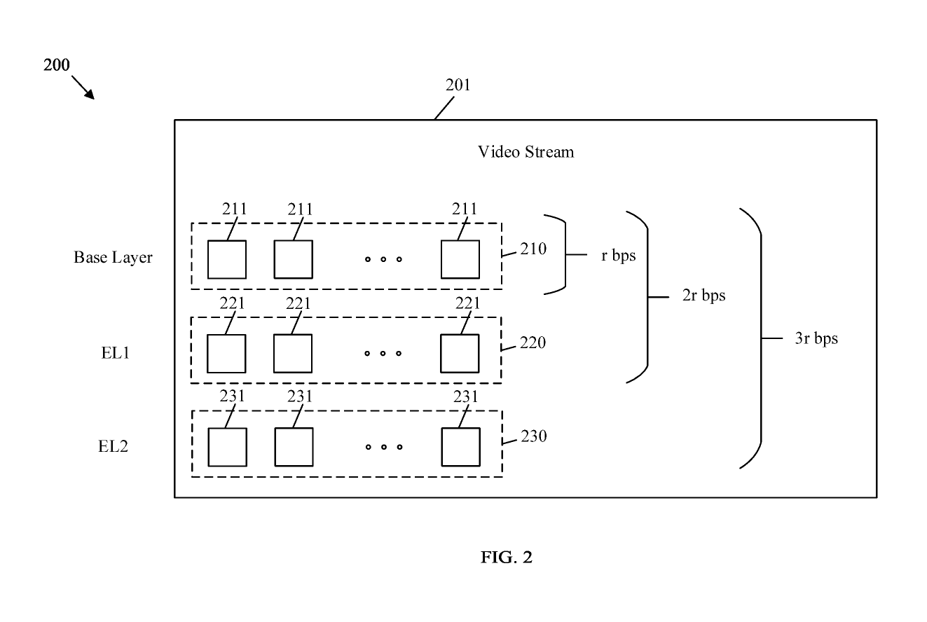

DASH is a scheme for video streaming. In DASH, a video content is represented in multiple representations with different quality levels. Each representation is partitioned into a sequence of segments each comprising a short playback time of the video content. Examples of multiple representations are adaptive video streaming representations as described in FIG. 1 and SVC representations as described in FIG. 2. A DASH client begins with requesting a media presentation descriptor (MPD) from a DASH server. The MPD describes the video content and the available quality levels. Subsequently, the DASH client adaptively requests the segments with suitable video quality based on network conditions observed during the streaming process.

FIG. 1 is a schematic diagram illustrating an embodiment of an adaptive video streaming representation scheme 100. The scheme 100 may be employed by a content delivery system, such as a DASH system. In the scheme 100, a video stream 101 is represented by a plurality of representations 110. Each representation 110 provides a different quality level such as a different playback bit rate. Each representation 110 is partitioned into a plurality of segments 111. Each segment 111 comprises a short interval of playback time. A content server stores each segment 111 as a file and each representation 110 in a different set of files. A client may switch between different video quality levels during a playback session by selecting a next playback segment 111 from any of the representations 110 depending on network conditions such as available bandwidths and/or network latencies.

FIG. 2 is a schematic diagram illustrating an embodiment of a SVC representation scheme 200. The scheme 200 may be employed by a content delivery system, such as a DASH system. The scheme 200 is an alternative video representation scheme. Unlike adaptive video streaming, SVC allows higher bit rate versions to utilize information available in lower bit rate versions. In the scheme 200, a video stream 201 is represented by a base layer 210, a first enhancement layer 220 shown as EL1, and a second enhancement layer 230 shown as EL2. The base layer 210 is partitioned into a plurality of segments 211. The first enhancement layer 220 is partitioned into a plurality of segments 221. The second enhancement layer 230 is partitioned into a plurality of segments 231. Each of the segments 211, 221, and 231 comprises a short interval of playback time, which may be any amount of time such as about 2 seconds, about 5 seconds, or about 10 seconds). The base layer 210 provides a playback bit rate at a base rate, denoted as r bits per second (bps). The first enhancement layer 220 in combination with the base layer 210 provides a playback bit rate at double the base rate, denoted as 2r bps. The second enhancement layer 230 in combination with the base layer 210 and the first enhancement layer 220 provides a playback rate at three times the base rate, denoted as 3r bps. Similar to the scheme 100, a content server stores each segment 211, 221, and 231 as a file. A client may switch between different video quality levels during a playback session by selecting a next playback segment 211, 221, and/or 231 from the base layer 210, the first enhancement layer 220, and/or the second enhancement layer 230, respectively, depending on network conditions such as available bandwidths and/or network latencies. It should be noted that the scheme 200 may support any number of enhancement layers.

Coded caching is a content caching and delivery technique that serves different content requests from users with a single coded multicast transmission based on contents cached at user devices. One focus of coded caching is to jointly optimize content placement and delivery for downloadable files. Caching of video streams may be more complex due to the different representations as shown in the schemes 100 and 200. Since a large amount of contents in the Internet are streaming videos, applying coded caching to streaming services may improve network performance. However, the current coded caching schemes that are used for downloadable files are relatively static and may not address the dynamic server-client interactions in streaming services.

Disclosed herein are various embodiments of a coded caching-based system for video streaming and content placement schemes. The coded caching-based system employs a coordination node to group and identify coding opportunities based on content requests from clients and the clients' cache contents. A coding opportunity is present when a first file requested by a first client is cached at a second client and at the same time a second file requested by the second client is cached at the first client. When a coded opportunity is present among a group of client requests, the coordination node requests a server to deliver a single coded content to satisfy all the client requests. Thus, the coordination node is referred to as a c4 coordinator. Upon receiving the coded content delivery request, the server encodes all the requested files into a single common coded file, for example, by performing bitwise XOR on all the requested files. Upon receiving the coded file, the c4 coordinator sends the coded file to all corresponding clients using multicast transmission. In addition, the coded caching-based system employs a local proxy between each client and the c4 coordinator. Each local proxy has direct access to a local cache of a corresponding client. All client requests are directed to corresponding local proxies. The local proxies act as a decoding node to decode coded content received from the c4 coordinator using cache contents of corresponding clients and send the decoded file to the corresponding clients. The disclosed embodiments further consider the multiple representations of video streams for content placement to increase coded caching gain. Although the disclosed embodiments are described in the context of video streaming using DASH, the disclosed embodiments are suitable for use in any content delivery networks (CDNs) and are applicable to any type of contents.

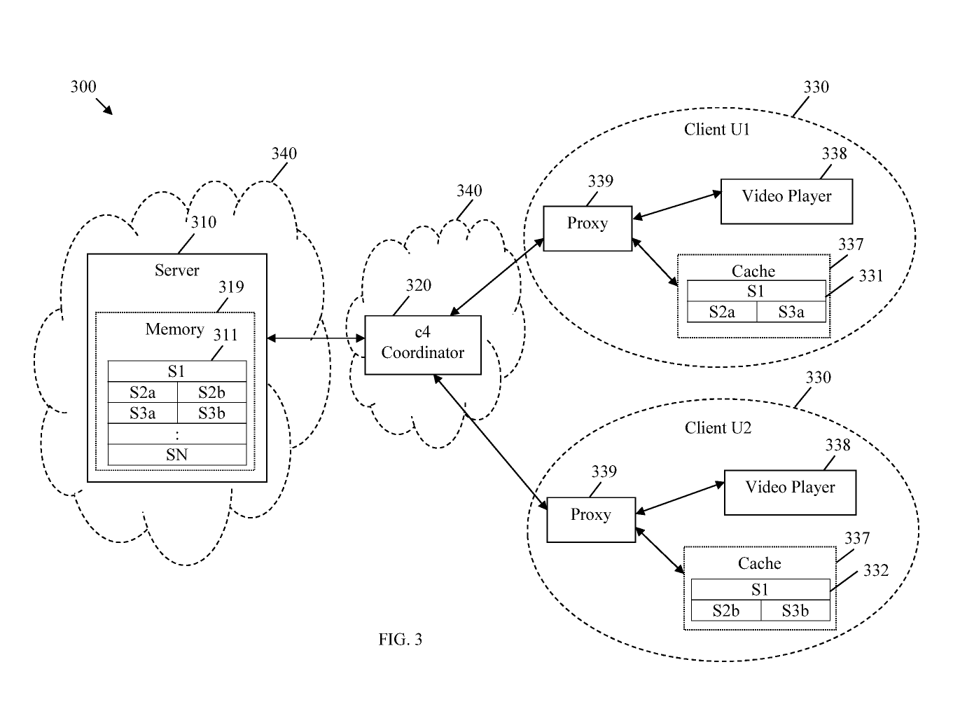

FIG. 3 is a schematic diagram of an embodiment of a coded caching-based content delivery system 300. In an embodiment, the system 300 is a DASH system and employs the scheme 100 or 200 to stream videos. The system 300 comprises a server 310, a c4 coordinator 320, and a plurality of clients 330 communicatively coupled to each other via one or more networks 340 such as the Internet, a wireline network, and/or a wireless network. For example, the server 310 is located in the Internet and the c4 coordinator 320 is located at a location such as a base station or an access point that is close to the clients 330.

The server 310 may be any hardware computer server configured to send and receive data over a network for content delivery. The content may include video, audio, text, or combinations thereof. The server 310 comprises a memory 319, which may be any device configured to store contents. As shown, files 311 shown as S1, S2a, S2b, S3a, S3b, . . . , SN are stored in the memory 319. For example, the files 311 correspond to multiple representations of video streams. In some embodiments, the server 310 may store the files 311 in external storage devices located close to the server 310 instead of the memory 319 internal to the server 310. The server 310 communicates and delivers contents to the clients 330 via the c4 coordinator 320. Upon receiving a coded content delivery request from the c4 coordinator 320, the server 310 performs coded caching to deliver a single common coded content to serve multiple clients' 330 requests, as described more fully below.

The clients 330 are shown as U1 and U2. The clients 330 may be any user devices such as computers, mobile devices, and/or televisions configured to request and receive content from the server 310. Each client 330 comprises a cache 337, a video player 338, and a proxy 339. The caches 337 are any internal memory configured to temporarily store files 331 or 332. For example, the server 310 caches portions of the files 311 at the clients' 330 caches 337 during off-peak hours. As shown, the files S1, S2a, and S3a 311 are cached at the client U1 330's cache 337 shown as files 331, and the files S1, S2b, and S3b 311 are cached at the client U2 330's cache 337 shown as files 332. The video players 338 may comprise software and/or hardware components configured to perform video decoding and playback.

Each proxy 339 may be an application or a software component implemented in a corresponding client 330. Each proxy 339 has direct access to the cache 337 and the video player 338 of the corresponding client 330. The proxy 339 acts as an intermediary between the video player 338 and the server 310. The video player 338 directs all content requests to the proxy 339. During a video playback, the proxy 339 may directly access the files 331 or 332 that are cached at the cache 337 for playback when requested by the video player 338. When a requested content is not stored at the cache 337, the proxy 339 forwards the video player's 338 requests to the c4 coordinator 320. The proxy 339 reports the contents of the cache 337 such as the files 331 and 332 cached to the c4 coordinator to enable the c4 coordinator to identify coding opportunity, as described more fully below. Upon receiving a coded content, the proxy 339 decodes the coded content using the contents cached at the cache 337 and sends the decoded content to the video player 338, as described more fully below. Although the proxies 339 are shown as separate components from the video players 338, the proxies 339 may be integrated into the video players 338.

The c4 coordinator 320 may be an application or a software component implemented in a network device. The c4 coordinator 320 is configured to coordinate coded caching for content delivery. The c4 coordinator 320 has a global view of cache contents such as the files 331 and 332 at the clients' 330 caches 337. For example, each client 330 informs the c4 coordinator 320 of internal cache contents during an initialization phase, as described more fully below. The c4 coordinator 320 determines whether a coding opportunity is present among content requests received from the clients' 330 proxies 339. A coding opportunity is present when the client U1 330 requests a file that is cached at the client U2's 330 cache 337 and at the same time the client U2 330 requests a file that is cached at the client U1's 330 cache 337. When a coding opportunity is present, the c4 coordinator 320 aggregates the requests and sends a coded content delivery request to the server 310. In response, the server 310 sends a single common coded content to the c4 coordinator 320. The c4 coordinator 320 sends the coded content to corresponding clients 330 using multicast transmission. Since the server 310 sends a single common coded content satisfying multiple requests instead of sending a separate file to serve each request, network bandwidth is reduced. It should be noted that although the c4 mechanisms are described in the context of video streaming, the c4 mechanisms may be applied to any type of content delivery application. In addition, the system 300 may comprise any number of clients, where the c4 coordinator 320 may determine coding opportunities among any number of requests from any number of clients and the server 310 may send a common coded content to corresponding clients. An optimal aggregation may be to find a minimum set cover for the requests and cache contents of the clients. Alternatively, a sub-optimal aggregation may be to find the best cover for two of the requests.

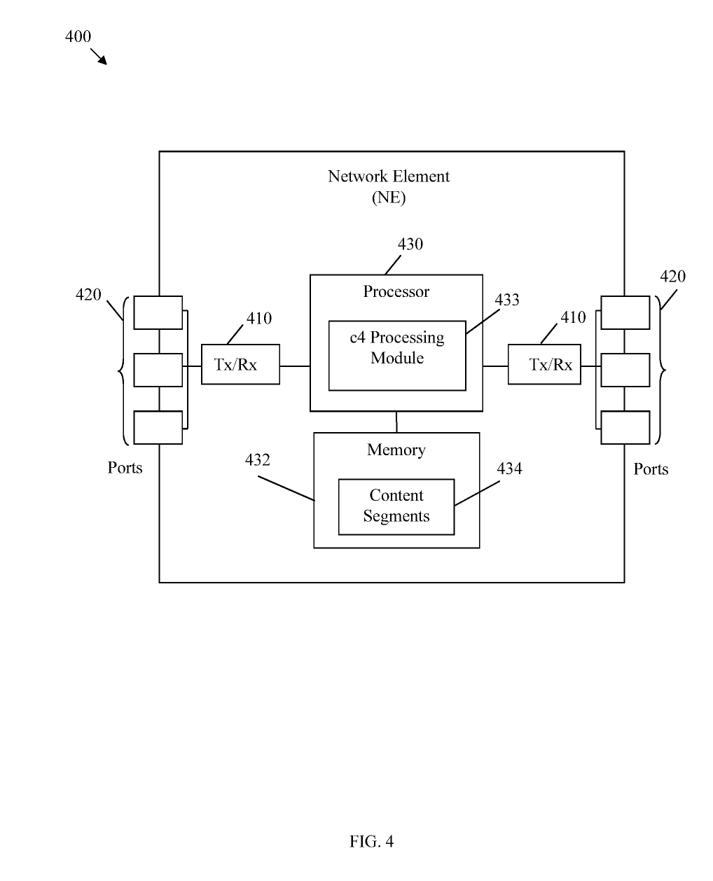

FIG. 4 is a schematic diagram of an embodiment of an NE 400 within a network such as the system 300. For example, NE 400 may act as the server 310, the c4 coordinator 320, or the clients 330 depending on the embodiments. NE 400 may be configured to implement and/or support the c4 mechanisms and schemes described herein. NE 400 may be implemented in a single node or the functionality of NE 400 may be implemented in a plurality of nodes. One skilled in the art will recognize that the term NE encompasses a broad range of devices of which NE 400 is merely an example. NE 400 is included for purposes of clarity of discussion, but is in no way meant to limit the application of the present disclosure to a particular NE embodiment or class of NE embodiments.

At least some of the features/methods described in the disclosure are implemented in a network apparatus or component, such as an NE 400. For instance, the features/methods in the disclosure may be implemented using hardware, firmware, and/or software installed to run on hardware. The NE 400 is any device that transports packets through a network, e.g., a switch, router, bridge, server, a client, etc. As shown in FIG. 4, the NE 400 comprises transceivers (Tx/Rx) 410, which may be transmitters, receivers, or combinations thereof. The Tx/Rx 410 is coupled to a plurality of ports 420 for transmitting and/or receiving frames from other nodes.

A processor 430 is coupled to each Tx/Rx 410 to process the frames and/or determine which nodes to send the frames to. The processor 430 may comprise one or more multi-core processors and/or memory devices 432, which may function as data stores, buffers, etc. The processor 430 may be implemented as a general processor or may be part of one or more application specific integrated circuits (ASICs) and/or digital signal processors (DSPs). The processor 430 comprises a c4 processing module 433, which may perform coded caching and may implement methods 500, 600, 700, 800, and 900, as discussed more fully below, and/or any other flowcharts, schemes, and methods discussed herein. As such, the inclusion of the c4 processing module 433 and associated methods and systems provide improvements to the functionality of the NE 400. Further, the c4 processing module 433 effects a transformation of a particular article (e.g., the network) to a different state. In an alternative embodiment, the coded caching processing module 433 may be implemented as instructions stored in the memory device 432, which may be executed by the processor 430.

The memory device 432 may comprise a cache for temporarily storing content, e.g., a random-access memory (RAM). Additionally, the memory device 432 may comprise a long-term storage for storing content relatively longer, e.g., a read-only memory (ROM). For instance, the cache and the long-term storage may include dynamic RAMs (DRAMs), solid-state drives (SSDs), hard disks, or combinations thereof. The memory device 432 is configured to store content segments 434 such as the files 311, 331, and 332. For example, the memory device 432 corresponds to the memory 319 and caches 337.

It is understood that by programming and/or loading executable instructions onto the NE 400, at least one of the processor 430 and/or memory device 432 are changed, transforming the NE 400 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable and that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions (e.g., a computer program product stored in a non-transitory medium/memory) may be viewed as a particular machine or apparatus.

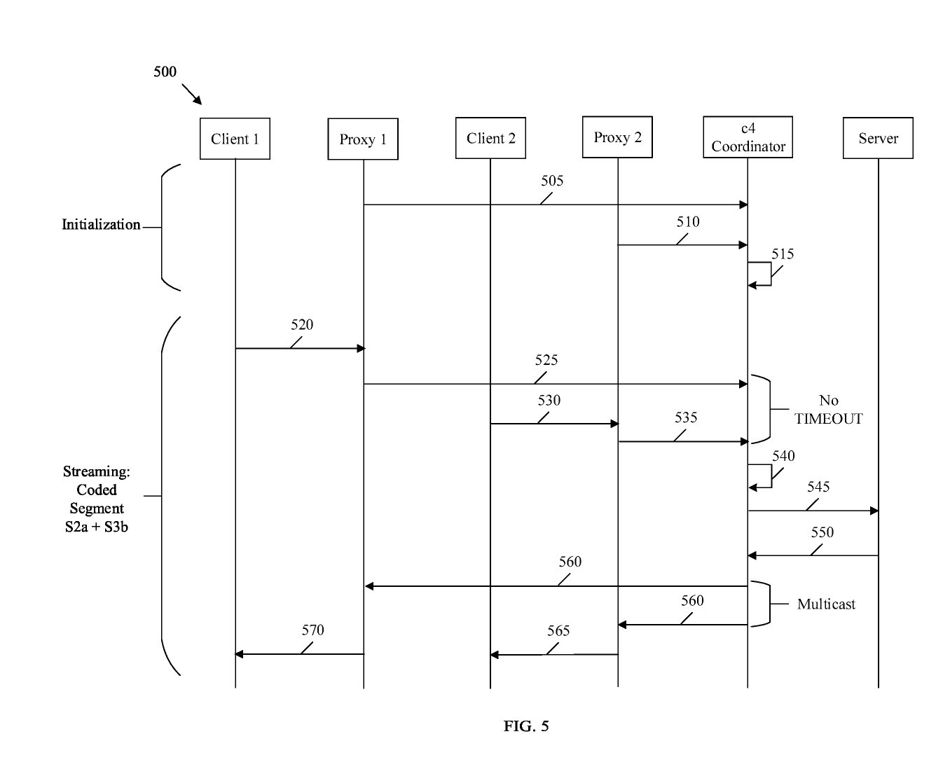

FIG. 5 is a protocol diagram of an embodiment of a method 500 of performing c4 in a coded caching-based content delivery system, such as the system 300. The method 500 is implemented between a server, a c4 coordinator, a client 1, a proxy 1, a client 2, and a proxy 2. The server is similar to the server 310. The c4 coordinator is similar to the c4 coordinator 320. The clients 1 and 2 represent content consuming applications of the clients 1 and 2, respectively. For example, the content consuming applications are video players similar to the video players 338. The proxy 1 and the proxy 2 are similar to the proxies 339. The proxy 1 is a local proxy of the client 1. The proxy 2 is a local proxy of the client 2. A local proxy has direct access to the client's cache and direct communications with the client's applications. The method 500 employs similar c4 mechanisms as in the system 300. The method 500 may employ the hypertext transfer protocol (HTTP) protocol for message exchange or any suitable message transfer protocol. The method 500 is implemented after the server cached a file S2a at the client 1 and a file S3b at the client 2, for example, during off-peak hours. The method 500 is divided into an initialization phase and a streaming phase. For example, the method 500 executes the initialization phase at the start of a content stream and repeats the execution of the streaming phase to stream each content segment of the content. The initialization phase begins at step 505. At step 505, the proxy 1 reports the client 1's cache content to the c4 coordinator. At step 510, the proxy 2 reports the client 2's cache content to the c4 coordinator. At step 515, the c4 coordinator updates a cache content information list based on the received reports. For example, the cache content information list comprises filenames of files that are cached in each of the client 1 and the client 2. In some embodiments, the initialization phase may be repeated at some time intervals to provide updated cache content information to the c4 coordinator.

The streaming phase begins at step 520, for example, during peak hours. At step 520, the client 1 sends a first request to the proxy 1 requesting a file S3b. At step 525, the proxy 1 determines that the requested file S3b is not present at the client 1's cache and dispatches the first request to the c4 coordinator. At step 530, the client 2 sends a second request to the proxy 2 requesting a file S2a. At step 535, the proxy 2 determines that the requested file S2a is not present at the client 2's cache and dispatches the second request to the c4 coordinator.

At step 540, the c4 coordinator determines that the first request and the second request arrive within a pre-determined timeframe. For example, the c4 coordinator starts a countdown timer with the pre-determined timeframe after receiving the first request from the client 1 and determines that the second request is received prior to the end of the count-down or the expiration of the timer. The duration of the pre-determined timeframe may be configured based on latency requirements of a streaming application in use. The c4 coordinator determines that a coding opportunity is present based on the cache content information list updated at the step 515, where the file S3b requested by the client 1 is cached at the client 2 and the file S2a requested by the client 2 is cached at the client 1. Thus, at step 545, the c4 coordinator sends an aggregated request to the server requesting a coded delivery of the files S2a and S3b.

At step 550, upon receiving the aggregated request, the server determines that the aggregated request is a request for a coded response and sends a single coded file carrying a coded caching combined version of the files S2a and S3b. For example, the single coded file comprises a file header indicating file sizes and filenames of the files S2a and S3b. At step 560, the c4 coordinator forwards the single coded file to the proxy 1 and the proxy 2 using multicast transmission.

At step 565, upon receiving the coded file, the proxy 1 decodes the coded file based on cached content (e.g., file S2a) at the client 1 and sends the decoded segment S3b to the client 1. For example, the proxy 1 examines the file header of the coded file. When the file header indicates more than one file size, the file is a coded file. The proxy 1 decodes the received coded file using files in the client 1's cache that are indicated in the file header. Similarly, at step 570, upon receiving the coded file, the proxy 2 decodes the coded file based on cached content (e.g., file S3b) at the client 2 and sends the decoded file S2a to the client 2. It should be noted that the method 500 may be applied to aggregate any number of client requests as long as a coding opportunity is present among the client requests.

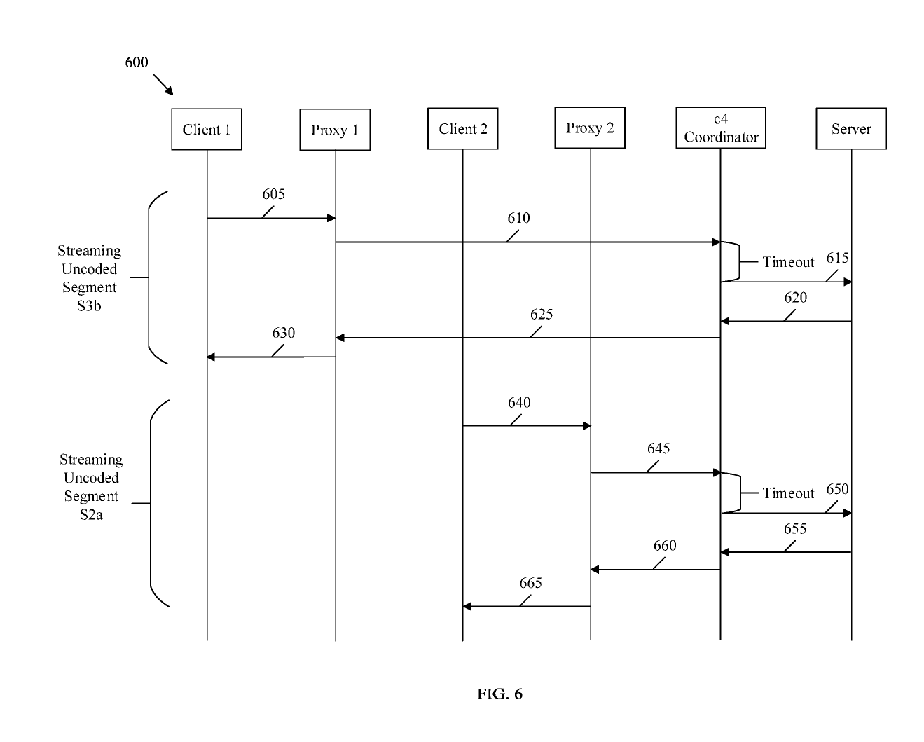

FIG. 6 is a protocol diagram of an embodiment of a method 600 of performing c4 in a coded caching-based content delivery system, such as the system 300, under a timeout condition. The method 600 is implemented between a server, a c4 coordinator, a client 1, a proxy 1, a client 2, and a proxy 2. The server is similar to the server 310. The c4 coordinator is similar to the c4 coordinator 320. The clients 1 and 2 represent content applications of the clients 1 and 2, respectively. The proxy 1 and the proxy 2 are similar to the proxies 339. The proxy 1 is a local proxy of the client 1. The proxy 2 is a local proxy of the client 2. The method 600 is implemented after completing initialization as described in the steps 505 to 515. For example, the server cached a file S2a at the client 1 and a file S3b at the client 2. At step 605, the client 1 sends a first request to the proxy 1 requesting a file S3b. At step 610, the proxy 1 dispatches the first request to the c4 coordinator. At step 615, the c4 coordinator detected a timeout condition and forwards the first request to the server. At step 620, the server sends the uncoded file S3b to the c4 coordinator. At step 625, the c4 coordinator forwards the uncoded file S3b to the proxy 1 using unicast transmission. At step 630, the proxy 1 forwards the uncoded file S3b to the client 1.

At step 640, the client 2 sends a second request to the proxy 2 requesting a file S2a. At step 645, the proxy 1 dispatches the second request to the c4 coordinator. At step 650, the c4 coordinator detected a timeout condition and forwards the second request to the server. At step 655, the server sends the uncoded file S2a to the c4 coordinator. At step 660, the c4 coordinator forwards the uncoded file S3b to the proxy 2. At step 665, the proxy 2 forwards the uncoded file S2a to the client 2. It should be noted that although the file S3b requested by the client 1 at the step 610 is cached at the client 2 and the file S2a requested by the client 2 at the step 645 is cached at the client, the two requests did not arrive at the c4 coordinator within a timeout period, thus no coding opportunity is available.

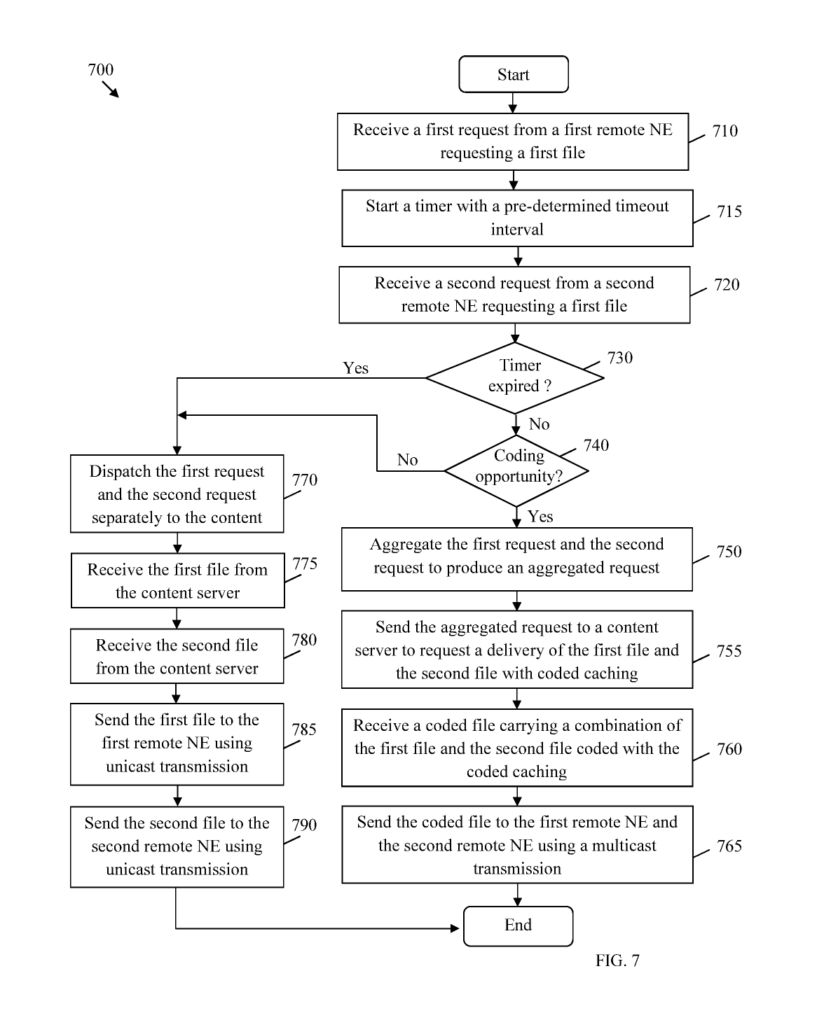

FIG. 7 is a flowchart of an embodiment of a method 700 of performing c4 proxy in a coded caching-based system, such as the system 300. The method 700 is implemented by a c4 coordinator such as the c4 coordinator 320 or the NE 400. The method 700 is similar to the methods 500 and 600. The method 700 is implemented after receiving local cache content information from remote NEs such as the clients 330 as described in the steps 505-515. For example, the local cache content information lists the filenames of the files cached at a remote NE's local cache such as the caches 337. At step 710, a first request is received from a first remote NE requesting a first file such as the files 311, 331, and 332. For example, the first request is sent by a proxy such as the proxies 339 executing on the first remote NE. At step 715, a timer is started with a pre-determined timeout interval. At step 720, a second request is received from a second remote NE requesting a second file. For example, the second request is sent by a proxy executing on the second remote NE.

At step 730, a first determination is made whether the second request is received prior to an expiration of the timer indicating an end of the pre-determined timeout interval. When the second request is received prior to the expiration of the timer, the method 700 proceeds to step 740. Otherwise, the method 700 proceeds to step 770.

At step 740, a second determination is made whether a coding opportunity is present. A coding opportunity is present when the first cache content information indicates that the second file is cached at the first remote NE and when the second cache content information indicates that the first file is cached at the second remote NE. When a coding opportunity is present, the method 700 proceeds to step 750. Otherwise, the method 700 proceeds to step 770.

At step 750, the first request and the second request are aggregated to produce an aggregated request. At step 755, the aggregated request is sent to a content server such as the server 310 to request a delivery of the first file and the second file with coded caching. At step 760, a coded file carrying a combination of the first file and the second file coded with the coded caching is received. For example, the coded file is received from the content server, which determines that the aggregated request is a request for a coded file. At step 765, the coded file is sent to the first remote NE and the second remote NE using a multicast transmission.

At step 770, when there is a timeout condition or when no coding opportunity is available, the first request and the second request are separately dispatched to the content server. At step 775, the first file is received from the content server. At step 780, the second file is received from the content server. At step 785, the first file is sent to the first remote NE using unicast transmission. At step 790, the second file is sent to the second remote NE using unicast transmission.

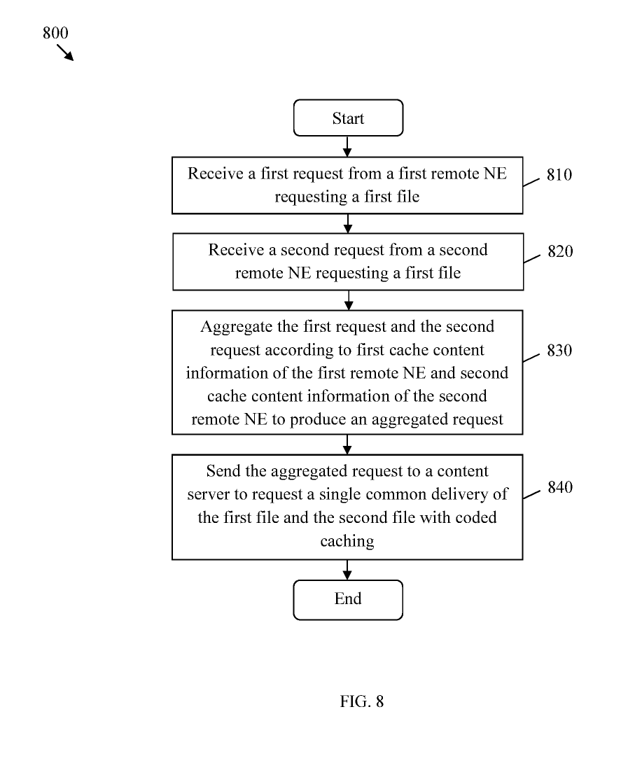

FIG. 8 is a flowchart of another embodiment of a method 800 of performing c4 proxy in a coded caching-based system, such as the system 300. The method 800 is implemented by a c4 coordinator such as the c4 coordinator 320 or the NE 400. The method 800 is implemented after receiving local cache content information from remote NEs such as the clients 330 as described in the steps 505-515. The method 800 employs similar mechanism as the methods 500, 600, and 700. At step 810, a first request is received from a first remote NE requesting a first file such as the files 311, 331, and 332. At step 820, a second request is received from a second remote NE requesting a second file. At step 830, the first request and the second request are aggregated according to first cache content information of the first remote NE and second cache content information of the second remote NE to produce an aggregated request. For example, the c4 coordinator determines that there is no timeout condition and a coding opportunity is available similar to the steps 730 and 740. At step 840, the aggregated request is sent to a content server such as the server 310 to request a single common delivery of the first file and the second file with coded caching.

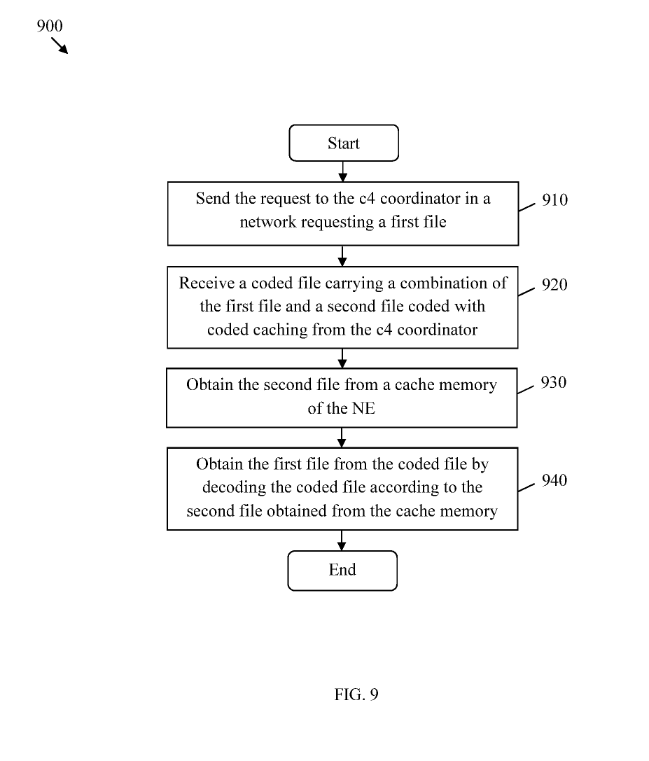

FIG. 9 is a flowchart of an embodiment of a method 900 of performing client proxy in a coded caching-based system, such as the system 300. The method 900 is implemented by a proxy application executing on a NE such as the client 330 and the NE 400. The method 900 employs similar mechanisms as the method 500. The method 900 is implemented after reporting cache content information of the NE to a c4 coordinator such as the c4 coordinator 320. For example, the NE caches a second file at a local cache such as the cache 337. The method 900 is implemented when receiving a request from the client. At step 910, the request is sent to the c4 coordinator in a network requesting a first file. At step 920, a coded file carrying a combination of the first file and a second file coded with coded caching is received from the c4 coordinator. At step 930, the second file is obtained from a cache memory of the NE. At step 940, the first file is obtained from the coded file by decoding the coded file according to the second file obtained from the cache memory. For example, the coded file is a bitwise XOR of the first file and the second file. Then, the decoding is performed by applying bitwise XOR between the coded file the second file.

As described above, a DASH server such as the server 310 may perform video streaming using adaptive video streaming with representations as shown in the scheme 100 or using SVC with representations as shown in the scheme 200. With multiple representations or versions of the same video available at the server, coding opportunity varies depending on the versions and/or segments cached at the clients such as the clients 330. Thus, the c4 mechanisms may provide different gains for different content placement schemes. The following embodiments analyze and evaluate different content placement schemes for adaptive video streaming and SVC.

To analyze the coded caching gain for adaptive video streaming, a set up with a server and K clients is used. The server stores N video files, each comprising a size of F bits at a base rate of r bps. Assume the size of a video file is directly proportional to the bit rate of the video. Then, the file size is scaled by the same factor α as the bit rate of the video. Each client has a cache capacity of M×F bits. The server uniformly caches M/N portion of each video file at each client. To cache versions with a bit rate of α×r bps, the server caches M/(αN) portion of each α×r bps video file at each client. As an example, K is set to a value of 2 to represent 2 clients and M is set to a value of N.

In a first scenario, when caching the video files at a base rate of about r bps, all N segments are cached at each client. Streaming at the base rate (e.g., α=1) requires no server bandwidth since the clients may stream from clients' caches. Streaming at a rate of about 2r bps requires a server bandwidth of about 4r bps (e.g., K×2r) since the 2r bps versions are not cached at the clients.

In a second scenario, when caching the 2r bps (e.g., α=2) version of the video files, each client caches half (e.g., M/(αN)=½) of each video file. For example, the server caches half of each video file at a first client and another disjoint half of each file at a second client. Streaming at a rate of about 2r bps requires a server bandwidth of about 2r bps (e.g., K×(1−M/(αN))×2r=2r) without coding and about r bps (e.g., K×(1−M/(αN))×½×2r=r) with coding. Streaming at a rate of about 3r bps requires a server bandwidth of about 3r bps (e.g., K×(1−M/(αN))×3r=3r) when the client playback the cached portion at the lower rate of about 2r bps and request the 3r bps version for the uncached portion. However, when the client desires to playback the entire video at 3r bps, a server bandwidth of about 6r bps (e.g., K×3r) is required.

In a third scenario, when caching the 3r bps (e.g., α=3) version of the video files, each client caches a third (e.g., M/(αN)=⅓) of each video file. For example, the server caches one third of each video file at a first client and another disjoint one third of each file at a second client. Then, streaming at a rate of about 3r bps requires a server bandwidth of about 4r bps (e.g., K×(1−M/(αN))×3r=4r) without coding. When applying coded caching, the required server bandwidth is about 3r bps, where one third of each requested file (e.g., K×M/αN×½×3r=2r) is coded and the remaining one third of each requested file is uncoded (e.g., K×M/αN×3r=2r). Streaming at a rate of about 4r bps requires a server bandwidth of about 4r bps (e.g., K×(1−M/(αN))×4r=3r) when the client playback the cached portion at the lower rate of about 3r bps and request the 4r bps version for the uncached portion. However, when the client desires to playback the entire video at 4r bps, a server bandwidth of about 8r bps (e.g., K×4r) is required. The following table summarizes the three scenarios:

| Bit rate | | |
|---|---|---|
| version cached (bps) | Playback rate (bps) | Bandwidth utilization (bps) |
| r | r | 0 |
| r | 2r | 4r |
| 2r | 2r | 2r (uncoded) |
| | | r (coded caching) |
| 2r | 3r | 3r (no coding opportunity) |
| 3r | 3r | 4r (uncoded) |
| | | 3r (coded caching) |
| 3r | 4r | 4r (no coding opportunity) |

Table 1—Summary of Coded Caching Gain for Adaptive Video Streaming

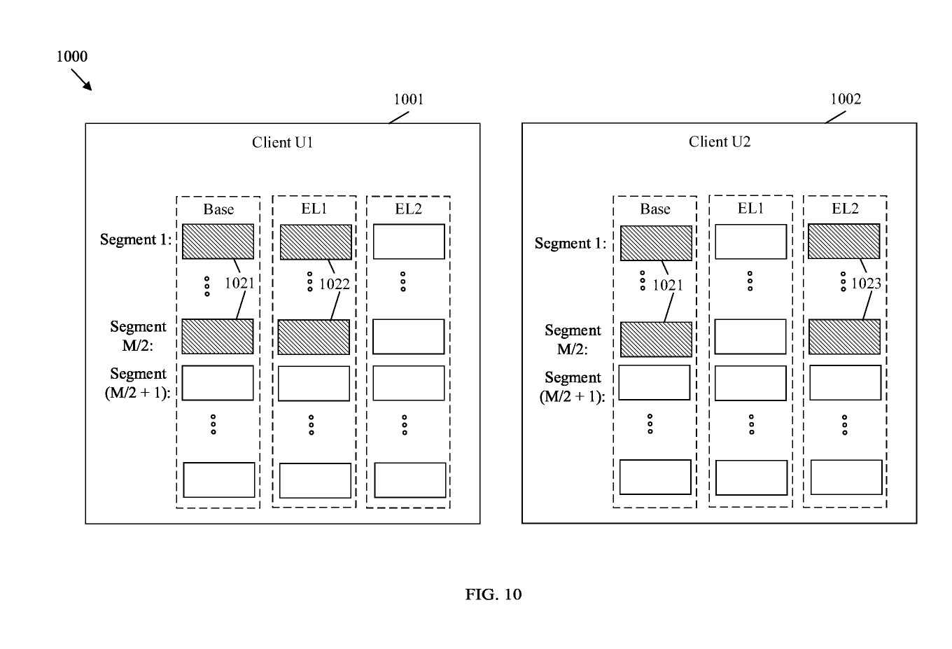

FIGS. 10-13 illustrate several content placement schemes for SVC. To analyze the coded caching gain for SVC, a set up with a server such as the server 310 and two clients such as the clients 330 is used. The server stores N video files, each comprising a size of F bits at a base rate of r bps. The N video files include a base layer file such as the segments 211 at the base layer 210, an EL1 file such as the segments 221 at the first enhancement layer 220, and an EL2 file such as the segments 231 at the second enhancement layer 230 for each video segment. The base layer files, the EL1 files, and the EL2 files provide increasing quality levels. Each client has a cache capacity of M×F bits. In FIGS. 10-13, the cached files or the cached file portions are shown as patterned rectangles. The average bandwidth for each content placement scheme is determined by considering a cache hit at both clients, a cache hit at one of the clients, and a cache miss at both clients.

FIG. 10 is a schematic diagram of an embodiment of a SVC content placement scheme 1000. The scheme 1000 may be employed by a server such as the server 310 to cache contents at clients U1 1001 and U2 1002 such as the clients 330. In the scheme 1000, the client U1 1001 and the client U2 1002 caches the same set of M/2 video segments, but at different layers. As shown, the client U1 1001 caches M/2 base layer files 1021 and M/2 EL1 files 1022 associated with the M/2 base layer files 1021. The client U2 1002 caches the same M/2 base layer files 1021 and M/2 EL2 files 1023 associated with the M/2 base layer files 1021. The average bandwidth usage in the scheme 1000 is shown below:

$$\frac{M}{2 N} \times \frac{M}{2 N} \times r + 2 \times \frac{M}{2 N} \times ( 1 - \frac{M}{2 N} ) \times 4 r ( 1 - \frac{M}{2 N} ) \times ( 1 - \frac{M}{2 N} ) \times 6 r = [ 6 - \frac{2 M}{N} - {( \frac{M}{2 N} )}^{2} ] \times r . \qquad ( 1 )$$

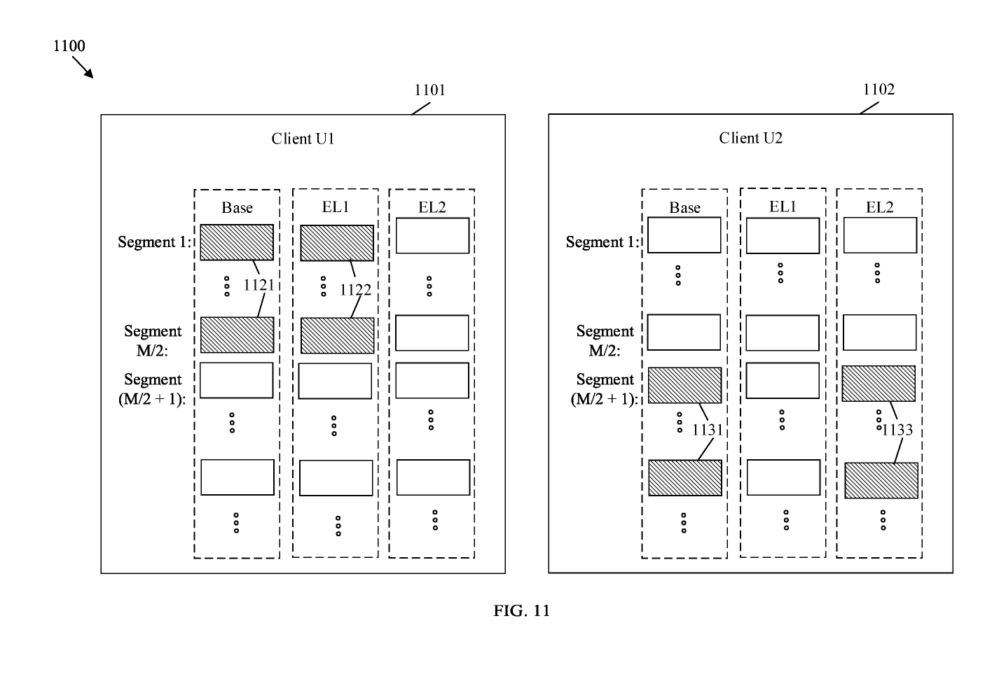

FIG. 11 is a schematic diagram of another embodiment of a content placement scheme 1100 for SVC. The scheme 1100 may be employed by a server such as the server 310 to cache contents at clients U1 1101 and U2 1102 such as the clients 330, 1001, and 1002. In the scheme 1100, client U1 1101 and a client U2 1102 caches the disjoint set of M/2 video segments and at different layers. As shown, the client U1 1101 caches a first set of M/2 base layer files 1121 and M/2 EL1 files 1122 associated with the M/2 base layer files 1121. The client U2 1102 caches a second disjoint set of M/2 base layer files 1131 and M/2 EL2 files 1133 associated with the M/2 base layer files 1131. The bandwidth usage for the scheme 1100 is shown below:

$${( \frac{M}{2 N} )}^{2} \times 2 r + 2 \times \frac{M}{2 N} \times ( 1 - \frac{M}{2 N} ) \times 4 r + {( 1 - \frac{M}{2 N} )}^{2} \times [ {( \frac{M / 2}{1 - ( M / 2 N )} )}^{2} \times 3 r + ( 1 - {( \frac{M / 2}{1 - ( M / 2 N )} )}^{2} ) \times 6 r ] . \qquad ( 2 )$$

The scheme 1100 reduces the bandwidth usage by

$$2 r {( \frac{M}{2 N} )}^{2}$$

when compared to the scheme 1000.

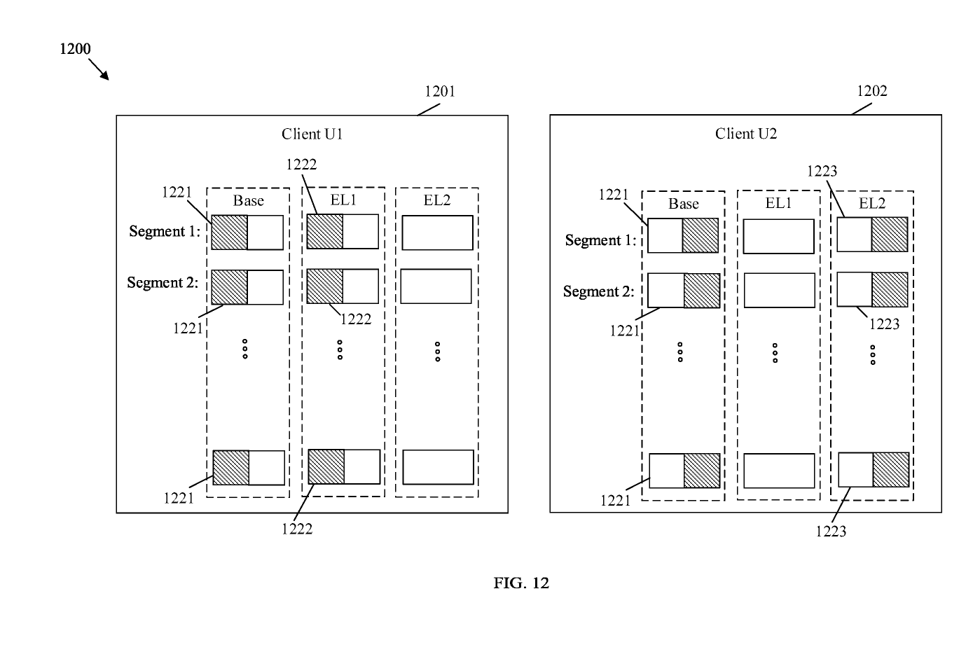

FIG. 12 is a schematic diagram of another embodiment of a content placement scheme 1200 for SVC. The scheme 1200 may be employed by a server such as the server 310 to cache contents at clients U1 1201 and U2 1202 such as the clients 330, 1001, 1002, 1101, and 1102. In the scheme 1200, the client U1 1201 caches first M/2N portions of base layer files 1221 and corresponding M/2N portions of EL1 files 1222. The client U2 1202 caches second disjoint M/2N portions of the base layer files 1221 and corresponding M/2N portions of EL2 files 1233. The bandwidth usage for the scheme 1200 is shown below:

$$\frac{M}{2 N} \times r + ( 1 - \frac{M}{2 N} ) \times 2 r + ( \frac{M}{2 N} ) \times r + ( 1 - \frac{M}{2 N} ) \times 2 r + 2 r = 6 - \frac{3 M}{N} . \qquad ( 3 )$$

The scheme 1200 reduces the bandwidth usage by

$$\frac{M}{N} - {( \frac{M}{2 N} )}^{2}$$

when compared to the scheme 1000.

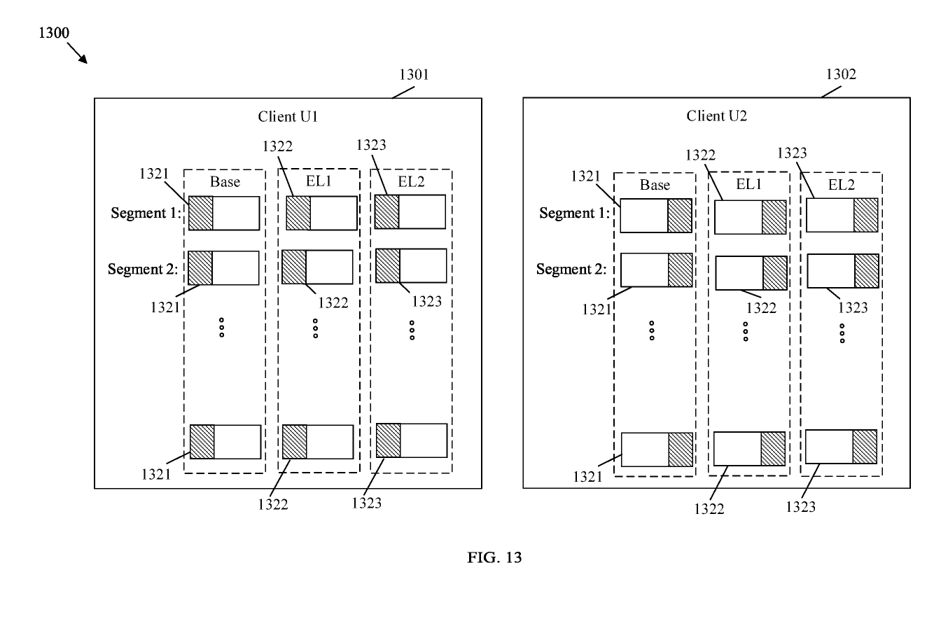

FIG. 13 is a schematic diagram of another embodiment of a content placement scheme 1300 for SVC. The scheme 1300 may be employed by a server such as the server 310 to cache contents at clients U1 1301 and U2 1302 such as the clients 330, 1001, 1002, 1101, 1102, 1201, and 1202. In the scheme 1300, a client U1 1301 caches first M/3N portions of base layer files 1321 and corresponding M/3N portions of EL1 files 1322. A client U2 1302 caches second disjoint M/3N portions of the base layer files 1321 and corresponding M/3N portions of EL2 files 1323. The bandwidth usage for the scheme 1300 is shown below:

$$( \frac{M}{3 N} ) \times r + ( 1 - \frac{2 M}{3 N} ) \times 2 r + ( \frac{M}{3 N} ) \times r + ( 1 - \frac{2 M}{3 N} ) \times 2 r + ( \frac{M}{3 N} ) \times r + ( 1 - \frac{2 M}{3 N} ) \times 2 r = 6 - \frac{3 M}{N} . \qquad ( 4 )$$

The scheme 1300 reduces the bandwidth usage by

$$\frac{M}{N} - {( \frac{M}{2 N} )}^{2}$$

when compared to the scheme 1000.

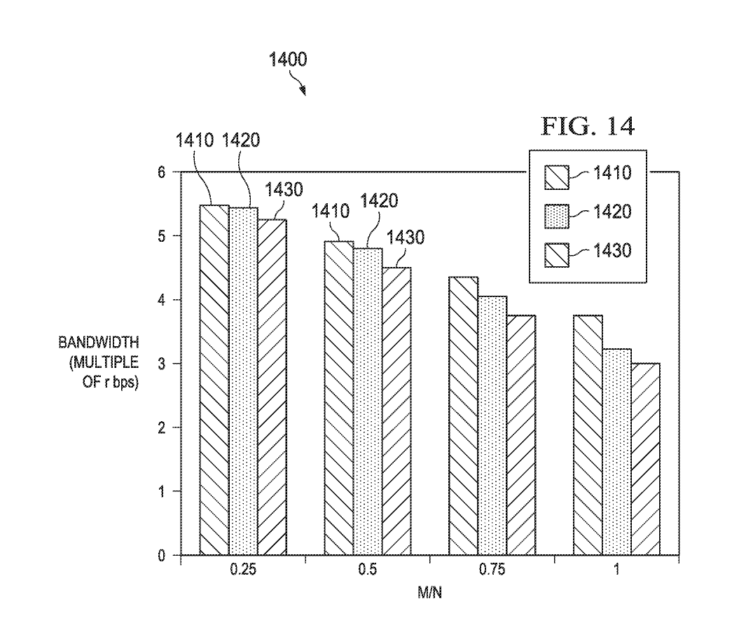

FIG. 14 is a graph 1400 comparing average bandwidth usages of the SVC content placement schemes of FIGS. 10-13. The x-axis represents values of M/N. The y-axis represents average bandwidth usage in units of r bps. The graph 1400 is generated with fixed values of M, N, and K. The bars 1410 show the average bandwidth usages for the scheme 1000 at various M/N ratios. The bars 1420 show the average bandwidth usages for the scheme 1100 at various M/N ratios. The bars 1430 show the average bandwidth usages for the scheme 1200 at various M/N ratios. As observed from the bars 1410-1430, the scheme 1100 provides bandwidth reduction over the scheme 1000 and the scheme 1300 provides bandwidth reduction over the scheme 1100.

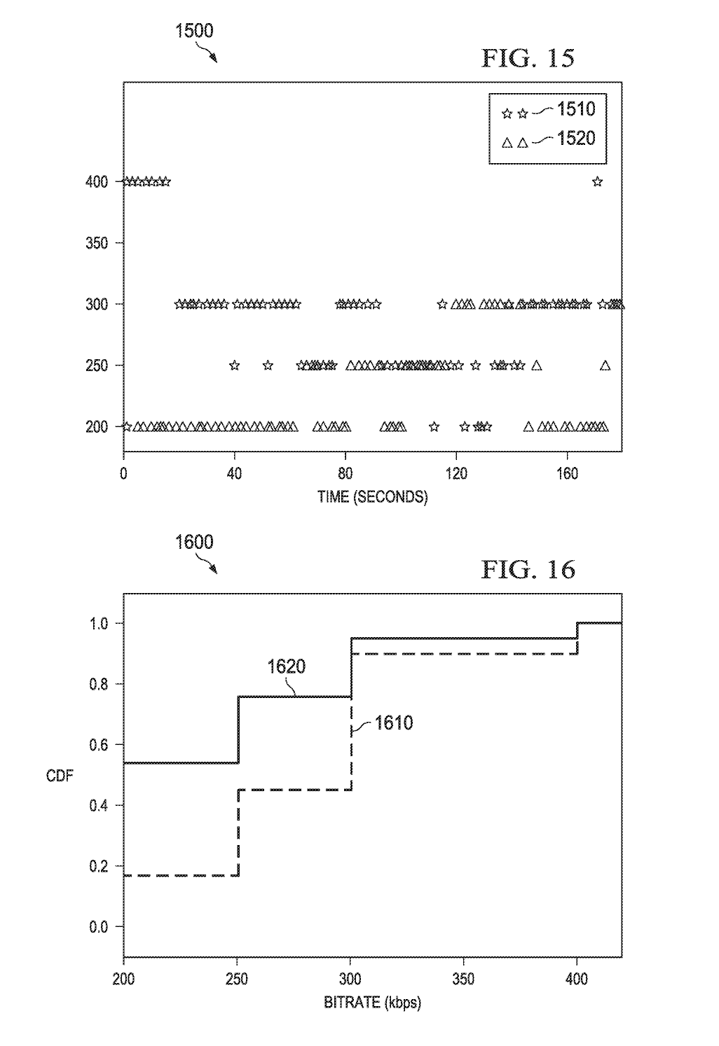

FIGS. 15-20 illustrate coded caching gain in video streaming with various timeouts. A timeout corresponds to a period of time where a c4 coordinator such as the c4 coordinator 320 may aggregate requests to take advantage of coding opportunity as described above in the methods 500, 600, and 700. The duration of the timeout may be configured to satisfy certain application latency requirement and/or real-time requirement. The experimental set up is set up similar to the system 300, where a server such as the server 310 communicates with a first client and a second client similar to the clients 330, 1001, 1002, 1101, 1102, 1201, 1202, 1301, and 1302 via a c4 coordinator similar to the coordinator 320. The set up provides a server link bandwidth sufficient to serve one client, for example, at about 500 kilobits per second (kbps). To evaluate the coded caching gain, coding opportunities are generated by caching the first client's requested content at the second client and caching the second client's requested contents at the first client. In FIGS. 15, 17, and 19, the x-axis represent time in units of seconds and the y-axis represent playback bit rates in units of kbps. In FIGS. 16, 18, and 20, the x-axis represent bit rates in units of kbps and the y-axis represent cumulative distributive function (CDF) in percentage (%).

FIG. 15 is a graph 1500 illustrating playback rates under a timeout period of zero second using the experimental set up described above. The plot 1510 with star symbols shows playback rates of the first client as a function of time. The plot 1520 with triangle symbols shows playback rates of the second client as a function of time. It should be noted that no coding opportunity is available at a timeout period of zero second. The timeout period of zero second is used as a reference for comparisons, as described more fully below.

FIG. 16 is a graph 1600 illustrating a CDF of playback rates under a timeout period of zero second using the experimental set up described above. The plot 1610 shows percentage of files as a function of playback rates for the first client. The plot 1620 shows percentage of files as a function of playback rates for the second client.

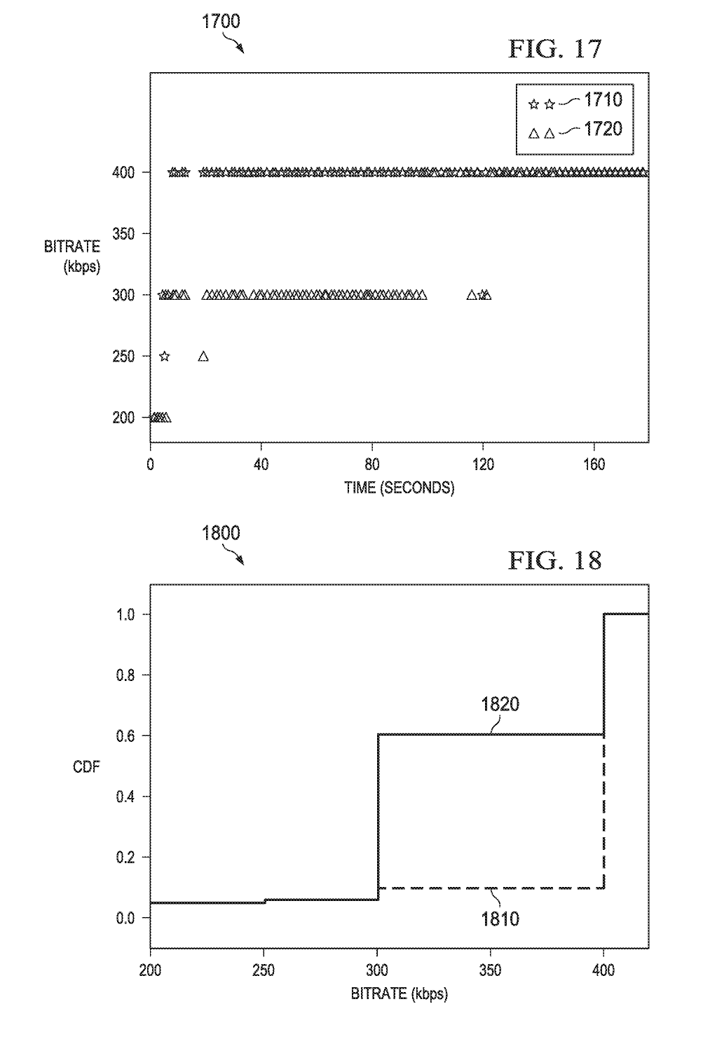

FIG. 17 is a graph 1700 illustrating playback rates under a timeout period of one second using the experimental set up described above. The plot 1710 with star symbols shows playback rates of the first client as a function of time. The plot 1720 with triangle symbols shows playback rates of the second client as a function of time.

FIG. 18 is a graph 1800 illustrating a CDF of playback rates under a timeout period of one second using the experimental set up described above. The plot 1810 shows percentage of files as a function of playback rates for the first client. The plot 1820 shows percentage of files as a function of playback rates for the second client.

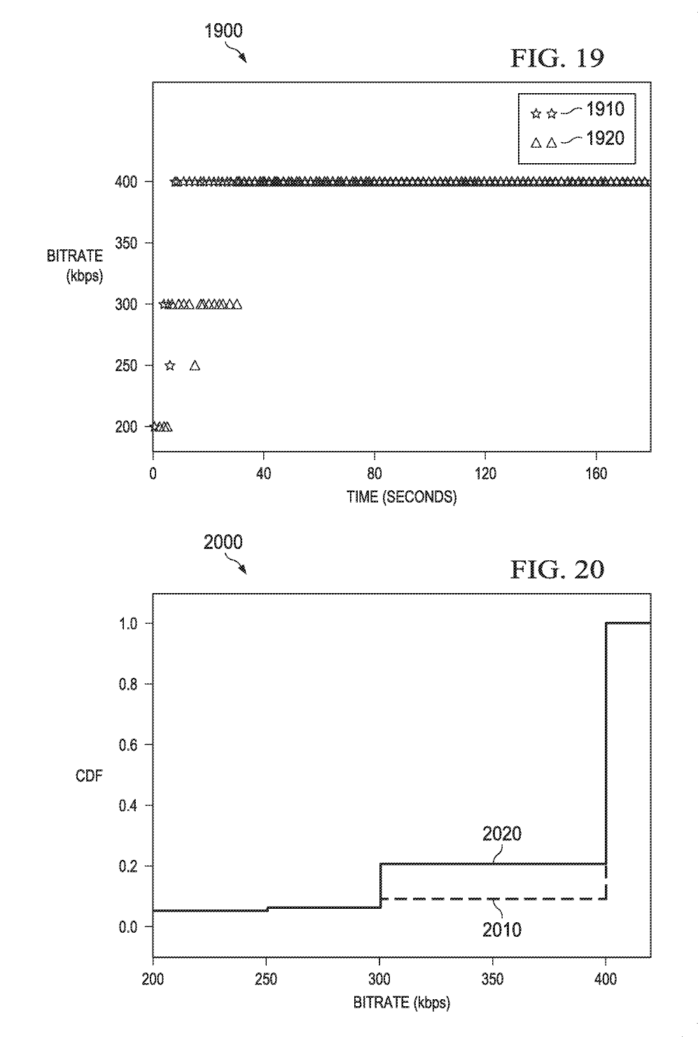

FIG. 19 is a graph 1900 illustrating playback rates under a timeout period of two seconds using the experimental set up described above. The plot 1910 with star symbols shows playback rates of the first client as a function of time. The plot 1920 with triangle symbols shows playback rates of the second client as a function of time.

FIG. 20 is a graph 2000 illustrating a CDF of playback rates under a timeout period of two seconds. The plot 2010 shows percentage of files as a function of playback rates for the first client. The plot 2020 shows percentage of files as a function of playback rates for the second client. As observed from the graphs 1600, 1800, and 2000, both the first clients and the second clients are able to playback at a higher bit rate as the timeout period increases from zero second to two seconds.

In an embodiment, a NE includes means for receiving a first request from a first remote NE requesting a first file, means for receiving a second request from a second remote NE requesting a second file, means for aggregating the first request and the second request according to first cache content information of the first remote NE and second cache content information of the second remote NE to produce an aggregated request, and means for sending the aggregated request to a content server to request a single common delivery of the first file and the second file with coded caching.

In an embodiment, a NE includes means for sending a request to a c4 coordinator in a network requesting a first file, means for receiving a coded file carrying a combination of the first file and a second file coded with coded caching from the c4 coordinator, means for obtaining the second file from a cache memory of the NE, and means for obtaining the first file from the coded file by decoding the coded file according to the second file obtained from the cache memory.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented by a network element (NE) configured as a coordinated content coding using caches (c4) coordinator, the method comprising:
receiving, via a receiver of the NE, a first request from a first remote NE requesting a first file;
receiving, via the receiver, a second request from a second remote NE requesting a second file;
aggregating, via a processor of the NE, the first request and the second request according to first cache content information of the first remote NE and second cache content information of the second remote NE to produce an aggregated request; and
sending, via a transmitter of the NE, the aggregated request to a content server to request a single common delivery of the first file and the second file with coded caching.

2. The method of claim 1, further comprising determining, via the processor, that a coding opportunity is present when the first cache content information indicates that the second file is cached at the first remote NE and when the second cache content information indicates that the first file is cached at the second remote NE, wherein the first request and the second request are aggregated when determining that the coding opportunity is present.

3. The method of claim 1, further comprising:
starting, via the processor, a timer with a pre-determined timeout interval upon receiving the first request; and
determining, via the processor, that the second request is received prior to an expiration of the timer indicating an end of the pre-determined timeout interval,
wherein the first request and the second request are aggregated when determining that the second request is received prior to the expiration of the timer.

4. The method of claim 1, further comprising:
receiving, via the receiver, the first cache content information from the first remote NE; and
receiving, via the receiver, the second cache content information from the second remote NE.

5. The method of claim 1, further comprising:
receiving, via the receiver, a coded file carrying a combination of the first file and the second file coded with the coded caching; and
sending, via the transmitter, the coded file to the first remote NE and the second remote NE using a multicast transmission.

6. The method of claim 5, wherein the coded file comprises a bitwise exclusive-or (XOR) of the first file and the second file, and wherein the coded file comprises a file header indicating:
a first filename of the first file;
a first file size of the first file;
a second filename of the second file; and
a second file size of the second file.

7. The method of claim 1, further comprising:
receiving, via the receiver, at least an additional request from an additional remote NE requesting an additional file;
determining, via the processor, an optimal coding opportunity among the first request, the second request, and the additional request according to the first cache content information of the first remote NE, the second cache content information of the second remote NE, and additional cache content information of the additional remote NE; and
further aggregating the first request and the second request when determining that the optimal coding opportunity is between the first request and the second request.

8. The method of claim 1, wherein the first file and the second file are associated with a scalable video coding (SVC) encoded video stream represented by a plurality of base layer files at a base quality level, a plurality of first enhancement layer files associated with a first quality level higher than the base quality level, and a plurality of second enhancement layer files associated with a second quality level higher than the first quality level, wherein the first cache content information indicates that the plurality of base layer files and the plurality of first enhancement layer files are cached at the first remote NE, and wherein the second cache content information indicates that the plurality of base layer files and the plurality of second enhancement layer files are cached at the second remote NE.

9. The method of claim 1, wherein the first file and the second file are associated with a scalable video coding (SVC) encoded video stream represented by a plurality of base layer files at a base quality level, a plurality of first enhancement layer files associated with a first quality level higher than the base quality level, and a plurality of second enhancement layer files associated with a second quality level higher than the first quality level, wherein the first cache content information indicates that a first set of the plurality of base layer files and a second set of the plurality of first enhancement layer files associated with the first set are cached at the first remote NE, wherein the second cache content information indicates that a third set of the plurality of base layer files and a fourth set of the plurality of second enhancement layer files associated with the third set are cached at the second remote NE, and wherein the first set and the third set are different.

10. The method of claim 1, wherein the first file and the second file are associated with a scalable video coding (SVC) encoded video stream represented by a plurality of base layer files at a base quality level and a plurality of first enhancement layer files associated with a first quality level higher than the base quality level, wherein the first cache content information indicates that a first portion of each of the plurality of base layer files and a second portion of each of the plurality of first enhancement layer files are cached at the first remote NE, wherein the second cache content information indicates that a third portion of each of the plurality of base layer files and a fourth portion of each of the plurality of first enhancement layer files are cached at the second remote NE, wherein the first portion and the third portion are different, and wherein the second portion and the fourth portion are different.

11. A network element (NE) configured to implement a coordinated content coding using caches (c4) coordinator, the NE comprising:
a receiver configured to:
receive a first request from a first remote NE requesting a first file; and
receive a second request from a second remote NE requesting a second file;
a processor coupled to the receiver and configured to aggregate the first request and the second request according to first cache content information of first remote NE and second cache content information of the second remote NE to produce an aggregated request; and
a transmitter coupled to the processor and configured to send the aggregated request to a content server to request a single common delivery of the first file and the second file with coded caching.

12. The NE of claim 11, further comprising a memory configured to store a cache list, wherein the receiver is further configured to:
receive the first cache content information from the first remote NE; and
receive the second cache content information from the second remote NE, and
wherein the processor is further configured to update the cache list according to the first cache content information and the second cache content information.

13. The NE of claim 12, wherein the processor is further configured to aggregate the first request and the second request when determining that the first file is cached at the second remote NE and the second file is cached at the first remote NE according to the cache list.

14. The NE of claim 11, wherein the processor is further configured to:
start a timer with a pre-determined timeout interval when the first request is received;
determine that the second request is received prior to an expiration of the timer indicating an end of the pre-determined timeout interval; and
aggregate the first request and the second request when determining that the second request is received prior to the expiration of the timer.

15. The NE of claim 11, wherein the receiver is further configured to receive a coded file carrying a combination of the first file and the second file coded with the coded caching, and wherein the transmitter is further configured to send the coded file to the first remote NE and the second remote NE using a multicast transmission.

16. The NE of claim 11, wherein the content server is a dynamic adaptive streaming over hypertext transfer protocol (HTTP) (DASH) server, and wherein the first remote NE and the second remote NE are DASH clients.

17. A method implemented in a network element (NE) comprising:
sending, via a transmitter of the NE, a request to a coordinated content coding using caches (c4) coordinator in a network requesting a first file;
receiving, via a receiver of the NE, a coded file carrying a combination of the first file and a second file coded with coded caching from the c4 coordinator;
obtaining, via processor of the NE, the second file from a cache memory of the NE; and
obtaining, via the processor, the first file from the coded file by decoding the coded file according to the second file obtained from the cache memory.

18. The method of claim 17, wherein decoding the coded file comprises performing a bitwise exclusive-or (XOR) operation on the coded file and the second file.

19. The method of claim 17, further comprising:
receiving, via the receiver, the request from a client application executing on the NE; and
sending, via the transmitter to the client application, the first file extracted from the decoding.

20. The method of claim 17, further comprising sending, via the transmitter, a cache report to the c4 coordinator indicating contents cached at the cache memory.
